(19) United States
(12) Patent Application Publication
(10) Pub. No.: US 2008/0086361 A1
(43) Pub. Date: Apr. 10, 2008

(54) Method and System for Rating Advertisements

(76) Inventor: Israel Eliezerov, Tel Aviv (IL)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/869,468

(22) Filed: Oct. 9, 2007

Related U.S. Application Data
(60) Provisional application No. 60/828,940, filed on Oct. 10, 2006.

(51) Int. Cl. G06Q 30/00; G06F 17/40

(52) U.S. Cl. 705/10

(57) ABSTRACT

The present invention is directed to a method and system that enables viewers of advertisements, such as users of the Internet (or any other interactive platform like interactive T.V.) to share with other viewers or users their opinion and experience regarding advertisements. The system can keep track of the advertisements without regard to where on the page they appear or which web pages they appear on. The method and system can provide the viewers or users with a rating or other indication of how others rated or reviewed the advertisement. The method and system can enable users to select or click on the advertisement, experience the link or presentation provided by selecting or clicking on the advertisement and then go to or return to place or presentation where they can answer questions about the advertisement and/or rate the advertisement. The system can store the answers to the questions and ratings and formulate a composite rating to appear with the advertisements in future presentations of the advertisements.

### CROSS-REFERENCE TO RELATED APPLICATIONS

This application claims any and all benefits as provided by law of U.S. Provisional Application No. 60/828,940 filed Oct. 10, 2006 which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

The present invention is directed to a method and system for evaluating or rating advertisements and providing information about the evaluations or ratings to subsequent viewers of the advertisements.

Many Internet websites generate their revenues by presenting advertisements to their visitors or users. These websites can be paid by advertisers directly or through those who represent the advertisers (e.g. advertising brokers, advertising networks.) Usually such advertisements provide a link to other web pages that relate to the advertisements (e.g. the advertiser's website, or a company that sells an associated product or service.). If a visitor or user is interested in the product or service being advertised, the visitor can click on the link to go to another website that provides more information about the product or service offering as well as provides the ability to purchase the product or service.

The interest of most Internet (or any other interactive platform) advertisers is that users click on their advertisements and get into a process which would benefit the advertisers (e.g. purchase the advertiser's product.)

For this purpose of getting Internet users to click their advertisements, many Internet advertisers are willing to practice aggressive and sometimes deceptive advertising practices. Advertisers present an offering in a way which is intended to persuade users to click on the advertisement, and later on, go through a process which will eventually benefit the advertisers. Advertisements and the processes that follow them are presented in an attractive or persuasive way, but which doesn't necessarily represent the offering in a sincere manner.

As a result, Internet users are tempted to click on advertisements and go through a process which eventually disappoints them. As a result, they may not get exactly the product or service or benefit they had in mind.

For example, a popular advertisement writes in big letters “Give us your email address and we will send you a free iPod”. Below this text there is a disclaimer written in small letters stating that in order to get the iPod users are also required to register to paid services. It also says that by entering their email addresses, users allow the advertiser to sell their email addresses to any 3^{rd} party. The advertisement is technically legitimate as it discloses the offer truthfully. However, many users don't notice the disclaimer, and therefore, misunderstand the advertisement. They enter their email addresses and expect to get a free iPod. Only after submitting their email addresses, users understand that in order to get a free iPod they are also required to pay for different kinds of services. These users are often disappointed.

Over time, many Internet users have become disappointed by and weary of Internet advertisements and therefore tend to click less on advertisements, as they do not have full trust in Internet advertising. As a result, in many cases, Internet users do not click on truthful and sincere advertisements and many honest advertisers with good, truthful and sincere offerings are being hurt.

In accordance with the invention, it is believed that users would be more inclined to click on advertisements if they believed that the advertisement could be trusted. Further, if users could communicate their opinion and/or experience regarding advertisements and their following experience, they could help each other in deciding which advertisement can be trusted.

Many Internet users are willing to volunteer in order to help the Internet community. There are many services on the Internet that use the power of their users to create their content. Two examples are Wikipedia.com which is an encyclopedia powered by users and Digg.com which is a website that presents links to news articles according to users' rating. These websites, as well as many others, don't reward or otherwise compensate the users who submit the information, and yet, many users cooperate.

Systems in the prior art get information from users regarding advertisements. However, none of the prior art systems give feedback to the user (the target of the advertising). The prior art systems are directed to addressing the commercial needs of the advertiser, not the user that clicks on the advertisement. These systems provide information to the advertiser or to other parties in order to let them improve their advertising campaigns.

20010037232 Method for tracking advertising effectiveness—The '232 patent application is directed to a method for tracking advertising effectiveness by rewarding audience members for viewing and responding to advertisements. Incentive rewards are given to audience members who report which advertisements they see. Each time an audience member reports viewing an advertisement, the member is given credits that can be redeemed for something of value. The invention provides feedback to advertisers about the effectiveness of their advertisements.

20040059625 Method for providing feedback to advertising on interactive channels—The '625 patent application is directed to enabling users to provide feedback about advertisements to their advertisers through a panel presented under the advertisements.

20030066071 Program recommendation method and system utilizing a viewing history of commercials—The 071 patent application is directed to a system that can provide an estimation that indicates whether a T.V. or Internet viewer is watching a program commercial not.

20030037333 Audience measurement system—The 333 patent application directed to a system that gathers information about what a TV audience watches.

However, none of the above applications is directed to a process that can keeps track of the advertisements and allows them to be rated from any web site. None of the above applications is directed to a system for providing information to the audience or users, for example, providing information about what other members of the audience or users thought about their experience with the advertisement.

### SUMMARY

The present application is about providing a service to the user community. Indeed, such service can also benefit some advertisers, but mainly the good ones, those that provide legitimate advertisements. The main effect is that users are able to get information about the advertisements and the process that follows from clicking on them from other users who have experience with the advertisement and the processes associated with clicking on them. Further, the prior art systems are only concerned with the effectiveness of the advertisement as displayed to the potential customer and its ability to attract potential customer and entice them to click on the associated link. None of the prior art systems allow the users to give their opinion regarding the full experience including the process—from clicking on the advertisement to providing the premise. The only feedback provided by the prior art systems relates to whether the advertisement is likely to induce potential customers to click on the associated link.

The present invention is directed to a method and system that enables viewers of advertisements, such as users of the Internet (or any other interactive platform like interactive T.V.) to share with other viewers or users their opinions and experiences regarding advertisements. The system can keep track of the advertisements without regard to where on the page they appear or which web pages they appear on. The method and system can provide the viewers or users with a rating or other indication of how other viewers or users rated, reviewed or interacted with the advertisement. The method and system can enable users to select or click on the advertisement, experience the link or presentation provided by selecting or clicking on the advertisement and then go to or return to a place or presentation where they can answer questions about the advertisement and/or rate the advertisement. The system may also analyze user's interaction with an advertisement and the process that follows it. The system can store the gathered information and ratings and formulate a composite rating to appear with the advertisements in future presentations of the same or similar advertisements on the same or different web pages or on the same or different presentations in other interactive media.

### BRIEF DESCRIPTION OF THE FIGURES

FIG. 1 is a block diagram of a system according to the invention.

FIGS. 2A and 2B are a diagrammatic view of a flow chart according to the invention.

FIG. 3 shows a diagram of an advertisement having a link enabling an end user to rate an advertisement according to the invention.

FIG. 4 shows a diagram of a pop-up window enabling an end user to rate an advertisement according to the invention.

FIG. 5 shows a diagram of an advertisement providing an end user with a rating of an advertisement according to the invention.

### DETAILED DESCRIPTION OF PREFERRED EMBODIMENTS

In accordance with the present invention, Internet users are willing to contribute to the Internet community by providing feedback about their experiences concerning advertisements. In doing so, Click-through on advertisements could be higher or increased if users had information from other users which could help them to decide which advertisements can be trusted.

The present invention enables users to share their experiences concerning advertisements and product/service offerings with other users, so subsequent users can decide whether to click on an advertisement.

The system according to the invention enables users to submit or get information regarding the advertisements they see on the Internet or on any other interactive platform (like interactive T.V.). Users can submit information about their experience with an advertisement by clicking on a link that can be adjacent to the advertisement or presented in a separate frame or browser control or toolbar. The additional information (or a link to it) can be presented near the advertisements. Such information can be a rating, such as an average grade which users give to an advertisement, or users' opinions etc. Upon user's consent, information can be gathered automatically according to users' interaction with advertisement and/or the process that follows it. The information presented near the advertisements can be also extended and include information provided by other parties like experts, the service provider, the advertisers, the website that presents the advertisement or any other party.

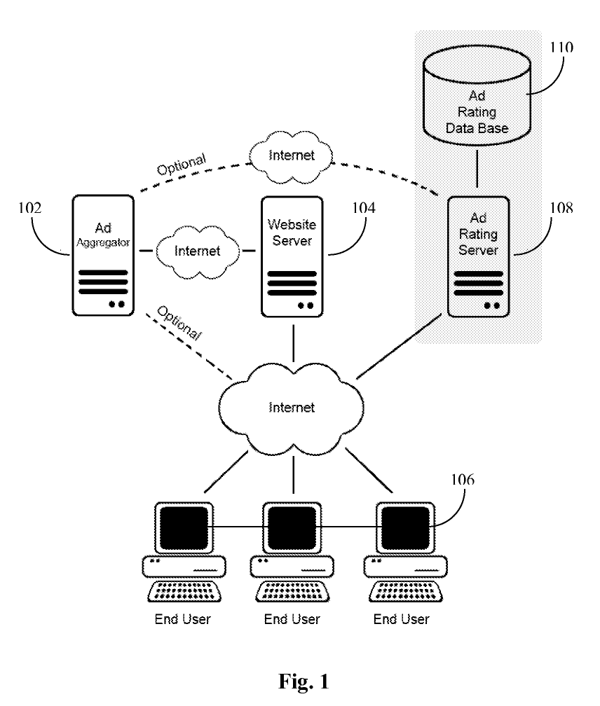

FIG. 1 shows a system 100 according to the invention. The system 100 can include Ad Aggregator 102, Website Server 104, End Users Computers 106, Ad Rating Server 108, and Ad Rating Data Base 110.

The Ad Aggregator 102 can be a service which manages advertisements. Advertisers usually register to such service which distributes and manages their advertisements. The Advertising Aggregator distributes the advertisements to websites and, in some cases, keeps track of advertisement views and click-throughs which are used to determine advertising revenue and revenue sharing. An example of such service is Google Ad-Sense. An advertiser is any entity which tries to promote something, such as a product, a service, a brand or an idea. The advertiser presents its message to the audience through advertisements. The audience is the demographic group or groups of people that the advertiser desires to advertise to by exposing the audience to the advertising message. In addition to being exposed to their advertisement, it is also the intent and desire of the advertiser to influence the audience to interact with the advertisement or change their behavior in response to the advertisement. Advertisements can appear on Internet websites in a graphic form, as text, as an animation or as an interactive unit. Advertisement can be also exposed through any other electronic device, including a mobile phone, a PDA (Personal Digital Assistant) or a gaming device. The advertisement can include a text that directs the user to go to a website.

Website Server or Web Server 104 can be a Server that hosts an Internet website. Web Server 104 can receive advertisements from Ad Aggregator 102 and present them as part of the content of its web pages. The operators of web sites and web servers 104 are generally referred to as Publishers, which are entities that publish content to an audience and in doing so expose advertisements to the audience. Publishers can include an internet website, a cellular operator or even software. In this context, Website Server 104 includes any system that provides an audience with content, a service or a product, and which is also able to promote advertisements. Such system can receive advertisements from Ad Aggregator 102 and present them along with or separate from, its content, service or product. The content, service or product can be an Internet website that provides an Internet search service, an email service, a game on a cellular phone, a navigation service on a PDA, or any other solution that a person or a group of people can view, hear or use.

End Users Computers 106 can be computers of users that surf the Internet and visit websites. The visited websites display advertisements on their web pages. End Users are the people who use the services or products provided by the Website Server. End Users get the service or product through communication between the End User Computer 106 and Website Server 104. Communication can be done in real-time. The End Users computer can be a Personal Computer, a PDA, a cellular phone, a game console or any other device that can communicate with a Website Server and display information. When an End User Computer 106 communicates with a Website Server 104 which is being managed by an entity that has an agreement with the company that owns the proposed service, the Website Server 104 can transfer to the End User Computer 106 information that relates to the proposed service. As a result, the End User will be able to get information about the advertisements that are presented to him or her by the Website Server 104. One way to operate this would be for the End User Computer 106 to download a Client Component from Website Server 104 or an associated computer. The Client Component can be a piece of code, a small program, that can run on the End User Computer 106 and perform certain actions or functions. It can extract information about the advertisement or advertisements which are or will be presented to the End User by analyzing information which exists on the End User Computer 106. For example, the client component can look for an advertisement ID or text that is part of a web page presented on the End User Computer 106. Then, the Client Component can communicate from the End User Computer 104 with the Ad Rating Server 108 to exchange information regarding the proposed system. It can send to the Ad Rating Server 108 information that identifies an advertisement, as well as, other information that may relate to the End User Computer 106, and receive back from the Ad Rating Server 108, additional information about that advertisement. Then, it can provide this information to the End User, and enables the End User to receive or provide additional information about the advertisement. In addition, optionally, the Client Component can communicate directly with Ad Aggregator 102 in order to receive more information regarding the advertisements presented by the Website Server 104.

The Ad Rating Server 108 is the part of the system 100 that manages the proposed service. The Ad Rating Server 108 can be a computer or service or piece of code (a program) that aggregates information that is related to the rating of the advertisements. As described above, it can communicate with the End User Computer 106 in order to receive and send back information about advertisements. In addition, optionally, the Ad Rating Server 108 can communicate directly with the Ad Aggregator 102 in order to retrieve further information regarding an advertisement. It is also possible that the Ad Rating Server 108 can be a part of or on the same computer system as the Ad Aggregator Server 102 that manages the advertisements. In such case, the proposed service may be operated by the same entity that operates the Ad Aggregator 102, or by an entity that is related to such operator.

The Ad Rating Data Base 110 is the data base of the system 100. The Ad Rating Data Base 110 can store rating information as well as other information regarding the advertisements being rated by End Users. The term Data Base, refers to any form of stored information whether it is standard data bases like Microsoft SQL, MySQL, Oracle, through a file or group of files stored on a hard disk, or any other means that can receive information, obtain it or obtain information that is extracted from the received information, and send this information, or information that is extracted from the stored information back when needed. The Ad Rating Data Base 110 can communicate with the Ad Rating Server 108 or any other system or component that manages the system of the present invention, or can be part of such system 100.

When such users get to a website that has an agreement with the company that owns the proposed system, the Website Server 104 of such website downloads to its users the Client Component. The Client Component which runs on the End Users computers 106 communicates with Ad Rating Server 108 to exchange information regarding the proposed system. In addition, it is optional that the Client Component can communicate directly with Ad Aggregator 102 in order to receive more information regarding the advertisements presented by Website Server 104. Such communication can happen if there is an agreement between the company which owns the proposed system and the company which owns the Ad Aggregator 102. Ad Rating Server 108 can be the main part of the system that runs the proposed service. As described above, it can communicate with the Client Component which runs on the End Users Computers 106. In addition, it is optional that the Ad Rating Server 108 can communicate directly with Ad Aggregator 102 in order to retrieve more information regarding some advertisements. Such communication can happen if there is an agreement between the company which owns the proposed system and the company which owns the Ad Aggregator 102. Ad Rating Data Base 110 can be a data base of the proposed service. This data base can store rating information as well as other information regarding the advertisements. It can retrieve and send information to Ad Rating Server 108.

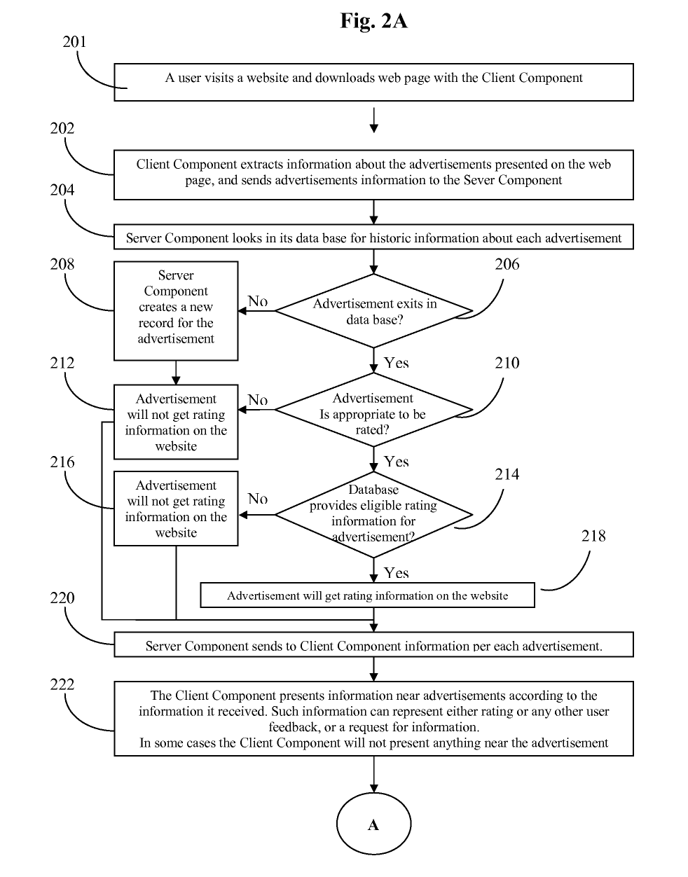

FIGS. 2A and 2B show a flow chart of the method according to the invention.

1. User A is visiting a website which is about bicycles. The user's computer downloads the webpage and the Client Component, 201. Client Component extracts information about the advertisements presented on the web page, and sends advertisements information to the Sever Component, 202. Server Component looks in its data base for historic information about each advertisement, 204. If, at 206, the advertisement does not exist in data base, the Server Component creates a new record for the advertisement at 208. If the advertisement does exist in the data base, the Server Component checks to see if the advertisement is appropriate to be rated at 210. This can be accomplished by a lookup in a separate database or by checking for key words in the advertisement referenced URL, the advertisement itself or the website that the advertisement links to. If the advertisement is not appropriate to be rated, no rating information will be provided with respect to that advertisement, 212. If the advertisement is appropriate to be rated, the Server Component checks the database for rating information about that advertisement at 214. If the database provides rating information about that advertisement, the webpage will get rating information to display adjacent to the advertisement on the User Computer, 218. If the database does not have rating information about the advertisement, no rating information will be provided with respect to that advertisement, 216. The Server Component sends to the Client Component information about each advertisement, 220

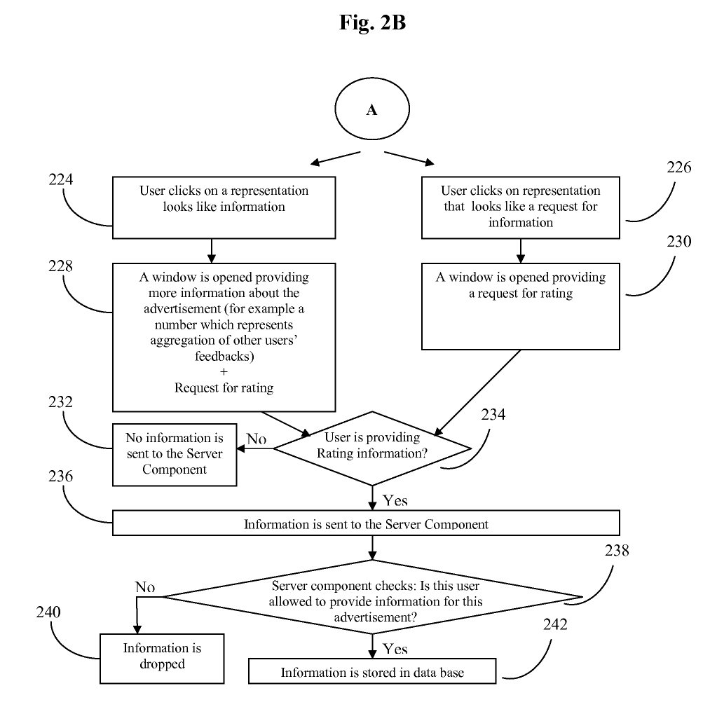

2. The User Computer displays the website and presents an advertisement provided by, for example, Google (Google, in this case, is the representative of the advertiser.). The advertisement says: “We sell bikes at the lowest prices.” The Client Component presents information near advertisements according to the information it received, 222. The information can represent either rating or any other user feedback, or a request for information or a link thereto. In some cases the Client Component will not present anything near the advertisement. For example, as shown in FIG. 3, on the left side of one advertisement, the user can be presented with an icon, such as a question mark.

When the user hovers with his/her mouse over the question mark icon, a text balloon appears saying “Click here to rate this ad”.

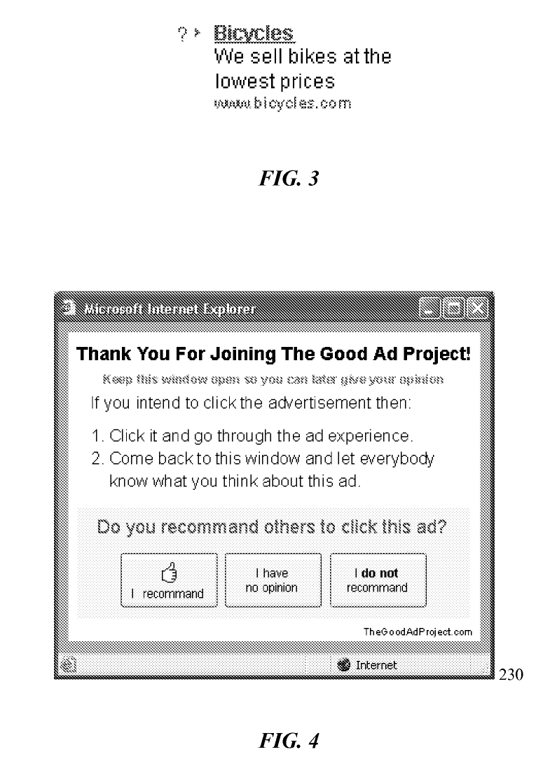

3. The user clicks the question mark icon and, as shown in FIG. 4, a small popup window appears, 230. The popup says: “Keep this window open so you can later give your opinion. If you intend to click the advertisement then: (1) Click it and go through the advertisement experience (2) Come back to this window and let everybody know what you think about this ad,” 230

4. The user keeps the popup window opened, and clicks the advertisement.

5. The advertisement takes the user to the advertiser's website where the user experiences the advertiser's presentation and views that the prices are indeed very low.

6. The user gets back to the popup window and clicks the button “I recommend clicking this ad”. If the user provides rating information, 234, the Client Component sends the rating information to the Server Component, 236. The Server component checks whether this user is allowed to provide information for this advertisement, 238. If yes, the information is stored in the database, 242 and if no, the information is dropped or discarded, 240.

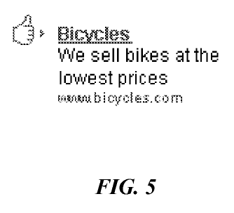

7. User B visits a website which is also about bicycles. The User's Computer displays the website and presents the same bicycle advertisement. As shown in FIG. 5, on the left side of the advertisement, an icon, indicating a rating, such as a “thumbs-up” icon appears.

8. When User B hovers with his/her mouse over the icon, a text appears saying “This advertisement is recommended by other users”. User B can click on the link (e.g., thumbs-up icon), 224 and User B can be provided with additional information about the recommendation, such as how many people recommended the advertisement and how many did not. User B can also provide there own evaluation of the advertisement, per steps 224-242.

9. The user clicks the ad.

In accordance with one embodiment of the invention, the system can include two components.

1. Client Component—A small piece of program code (e.g. written in JavaScript, VB Script, Java, etc.) which can be transferred to the End Users Computers 106 before or with the web page they visit. The Client Component or a link to the client component can be part of the web page that the user views and be transferred as part of the web page. It can also be downloaded as a part of the code that is managed by the Ad Aggregator 102, or, the page code, can directly or indirectly, request the download of it. Alternatively, the client component can be a program residing on the users computer 106, either stand-alone or as a plug-in to the users web browser.

2. Server Component—A server application which interacts with the Client Component. The Server Component can be a “stand alone” service, or can be a part of a different service, like the Ad Aggregator service.

It is also possible to implement the invention without the Client Component. If the proposed service is being managed by the same entity that manages the Ad Aggregator 102, or an entity that is related to the entity that manages the Ad Aggregator 102, then, the Ad Aggregator 102 or a different service that is managed by the same entity, can receive from users or present to users the rating information, or any other information which relates to the proposed service. In this embodiment, when the advertisement is sent to the end user, the Ad Aggregator 102 or the entity that is related to the Ad Aggregator 102 can include information about the rating to be displayed with the advertisement and a link to a web site or an application that allows the end user to rate the advertisement.

In accordance with the invention, when users get to a page that includes both advertisements and the client component, the Client Component can detect the advertisements on the page and determine information that can help the Server Component identify the advertisements. In other embodiments, the Client Component can be installed on the end user's computer 106 such that when a user gets a web page, the Client Component can detect the advertisements on the page and determine information that can help the server 108 component identify the advertisement. The information can be determined in many ways. For example, the Client Component can determine from information in the web page, an interface or a link with the parties that provide the advertisements (e.g. Google). In this case, the Client Component can communicate with these parties' servers and get basic information about the advertisements presented in the page. Alternatively, the Client Component can get this information by analyzing or parsing the page and determining information about the presented advertisements. The Client Component can send the information to the Server Component. The Server Component can interact with other parties' servers in order to gain additional information about the advertisements.

When the Server Component 108 gets the advertisements information, it looks for the advertisements in its data-base 110. If an advertisement is not found in the database 110, the Server Component 108 creates a new record for it. If an advertisement exists, it looks at the information that the data-base has about the ad. For each ad, the server can check to determine according to a predefined set of rules, whether the advertisement is appropriate to be rated. It is possible that some types of advertisements won't be rated due to policy, technical/graphical or other reasons.

For each advertisement that should be rated, the Server Component 108 can check to see if there is evaluation or rating information which is eligible to be displayed. For example, if only a few people rated an ad, then the system can, based on predefined rules, determine whether or not to make the rating information eligible to be displayed. There can be a minimal amount of review/evaluations/ratings/opinions that are needed before the system allows the ratings or evaluation information to be displayed.

As a result, each advertisement on the page could be designated as either rated or as requiring rating.

For each ad, the Server 108 can send back to the Client Component an indication of whether or not to present or display rating information to the end user 106, and if yes, what kind of information. For example, the Server Component can send for each advertisement, an image or a path/link to an image that could be displayed adjacent to the advertisement. Additional information, such as information to be displayed when the user hovers their mouse pointer over the ratings icon can also be provided.

The Client Component can present text and/or image information near the advertisements on the page according to the information it received from the Server Component 108. For example, the rating can be “recommended” (thumbs up) rating or “not recommended” (thumbs down) rating and when the user hovers the mouse pointer over the icon, the Client Component or the icon can enable more specific information to be displayed, such as “25 people recommended this advertisement and 9 people would not recommend this advertisement, your mileage may vary.”

While it can be desirable that near some or all the advertisements in the page, users are able to see rating indications, it is not necessary. Alternatively, the web page could have a link, such as a link to a trusted source, which provides for advertisement rating information. In this embodiment, when the user clicks on the link to the trusted source, information about the advertisements can be provided to the server of the trusted source and cause a window can pop up that displays rating information. The user can view prior rating information as well as rate advertisements on the page.

If the advertisement was defined by the Server Component as rated then the rating information can appear near the ad. The rating information can be presented in different forms. It can be an image that represents rating, like a thumb-up or a smiley. It can be a textual comment, a number or any other way which information can be presented.

If the advertisement was defined as requiring rating then a text/image can appear near the ad, asking the users to rate the ad. An example for such representation would be to present a question mark or the words “rate this ad” near the advertisement.

The users who visit the page see near the advertisements either representation of rating or a representation of a request for rating.

Users can click on or select the representations. If users click a representation of a request for rating, the Client Component can present a message (possibly through a new separated browser window.) The message can ask the users to submit their opinion regarding the advertisement presented near the clicked item. If users submit their opinion, the web page where the message is presented can send the data to the Server Component about the users' opinions. The Server Component 108 can determine if the submitted info is legitimate, if the user actually visited the website linked by the advertisement (for example, by looking for the presence of a cookie or other identifier or the users' IP address and corresponding URL—indicating the advertiser is doing the rating) and the rating might be disqualified if it is identified as fraud. If the rating is legitimate, it can be added to the data-base.

When users click on a rating icon or displayed information, a message could appear (possibly through a separated browser window.) The message can provide more info regarding the advertiser, the rating service and perhaps extends the information regarding the rated advertisement and its rating. The message can also permit the users to submit their opinion regarding the advertiser, the rating service, the rated advertisement and its rating. This information can be submitted to the Server Component.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A method for rating advertisements in web pages comprising:
receiving a client component from a first server, the client component being adapted to extract information about advertisements in received web pages;
receiving a web page including at least one advertisement;
the client component extracting information about at least one advertisement in the received web page;
sending at least a portion of the extracted information to an ad rating server; the ad rating server being coupled to an ad rating data base, the ad rating data base including rating information about advertisements;
searching the ad rating data base using the extracted information for rating information about the advertisement;
if rating information about the advertisement is found, sending the rating information about the advertisement to the client component; and
displaying to the end user, the rating information about the advertisement and the link to an application that allows the end user to provide information for rating the advertisement.

2. A method for rating advertisements in web pages comprising:
prior to sending an advertisement to an end user, searching a rating information database for information relating to a rating of the advertisement;
receiving, by an end user, a web page including the advertisement, information relating to the rating of the advertisement and a link to an application that allows the end user to provide information for rating the advertisement; and
displaying to the end user, the advertisement, the rating information about the advertisement and the link to the application that allows the end user to provide information for rating the advertisement.
